(19) United States
(12) Patent Application Publication
(10) Pub. No.: US 2014/0154977 A1
(43) Pub. Date: Jun. 5, 2014

(54) NON-CONTACT PROXIMITY-TYPE COMMUNICATION APPARATUS AND INFORMATION TERMINAL

(71) Applicant: Kabushiki Kaisha Toshiba, Tokyo (JP)

(72) Inventors: Koichi Sato, Tachikawa-shi (JP); Hiroyuki Hotta, Ome-shi (JP)

(73) Assignee: Kabushiki Kaisha Toshiba, Tokyo (JP)

(21) Appl. No.: 14/017,541

(22) Filed: Sep. 4, 2013

Related U.S. Application Data
(63) Continuation of application No. PCT/JP2013/057308, filed on Mar. 14, 2013.

(30) Foreign Application Priority Data
Nov. 30, 2012 (JP) 2012-263074

(51) Int. Cl. H04B 5/02

(52) U.S. Cl. CPC H04B 5/02
USPC 455/41.1; 455/90.2

(57) ABSTRACT

In a non-contact proximity-type communication apparatus of an embodiment, the apparatus is implemented on a wireless terminal includes a wireless circuit which transmits/receives a communication signal, and configured to transmit/receive the communication signal with another terminal using an induction electric field type non-contact communication method. The apparatus includes a coupling element includes at least two pieces whose surfaces face different directions, the coupling element electrically connected to the wireless circuit and placed at an end portion of the terminal.

### CROSS-REFERENCE TO RELATED APPLICATIONS

This application is a Continuation Application of PCT Application No. PCT/JP2013/057308, filed Mar. 14, 2013 and based upon and claiming the benefit of priority from Japanese Patent Application No. 2012-263074, filed Nov. 30, 2012, the entire contents of all of which are incorporated herein by reference.

### FIELD

Embodiments described herein relate generally to a non-contact proximity-type communication apparatus configured to perform data communication using electromagnetic field which functions as a communication medium and an information terminal comprising the non-contact proximity-type communication apparatus.

### BACKGROUND

In recent years, service using a non-contact proximity-type communication method such as, typically, a non-contact IC card and the like has become widespread rapidly. The non-contact proximity-type communication method is a bi-directional communication technique whose maximum communication distance is approximately 10 cm and which utilizes an electromagnetic field, acting as communication medium, having carrier frequency of 13.56 MHz. When such a non-contact proximity-type communication interface is implemented on a mobile information terminal such as a smart phone, tablet-type terminal, note-type personal computer and the like, the mobile information terminal can perform high-speed data communication with another mobile information terminal by simply placing the terminals in proximity to each other, and thereby, various services can be achieved.

Incidentally, in a mobile information terminal including a non-contact proximity-type communication interface, a device to perform communication with other terminals is generally placed on a single specific surface of a terminal body. For example, a smart phone having Felica (Trademark), a magnetic substance and coil are placed on a rear surface of a terminal body. Furthermore, in a note-type personal computer having Felica (Trademark) similarly, a magnetic substance and coil are placed on a palm rest of a terminal.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an exterior of a mobile information terminal comprising a non-contact proximity-type communication apparatus of first embodiment.

FIG. 2A is a rear view of the mobile information terminal comprising the non-contact proximity-type communication apparatus shown in FIG. 1.

FIG. 2B is a side view of the mobile information terminal comprising the non-contact proximity-type communication apparatus shown in FIG. 1.

FIG. 3 is a side view illustrating the enlarged non-contact proximity-type communication apparatus shown in FIG. 1.

FIG. 4 is a view used to explain an electromagnetic coupling action of the non-contact proximity-type communication apparatus shown in FIG. 3.

FIG. 5 is a side view illustrating a structure of a non-contact proximity-type communication apparatus of second embodiment.

FIG. 6 a view used to explain an electromagnetic coupling action of the non-contact proximity-type communication apparatus shown in FIG. 5.

FIG. 7 is a perspective view illustrating an exterior of a mobile information terminal comprising a non-contact proximity-type communication apparatus of third embodiment.

FIG. 8 is a perspective view illustrating the enlarged non-contact proximity-type communication apparatus shown in FIG. 7.

FIG. 9 is a perspective view illustrating a structure of a non-contact proximity-type communication apparatus of fourth embodiment.

FIG. 10 is a perspective view illustrating a note-type personal computer comprising a non-contact proximity-type communication apparatus of fifth embodiment.

FIG. 11 is a perspective view illustrating a note-type personal computer comprising a non-contact proximity-type communication apparatus of sixth embodiment.

FIG. 12 is a perspective view illustrating an enlarged main part of a note-type personal computer comprising a non-contact proximity-type communication apparatus of seventh embodiment.

FIG. 13 is a side view illustrating a structure of a non-contact proximity-type communication apparatus of eighth embodiment.

FIG. 14 is a side view illustrating a structure of a non-contact proximity-type communication apparatus of ninth embodiment.

FIG. 15 is a side view illustrating a structure of a non-contact proximity-type communication apparatus of tenth embodiment.

FIG. 16 is a side view illustrating a structure of a non-contact proximity-type communication apparatus of eleventh embodiment.

FIG. 17 is a perspective view illustrating an exterior of an information terminal comprising a non-contact proximity-type communication apparatus of twelfth embodiment.

### DETAILED DESCRIPTION

Hereinafter, several embodiments are explained referring to the figures.

### Embodiment 1

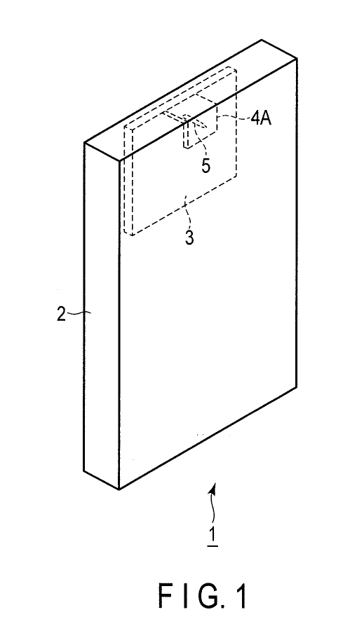

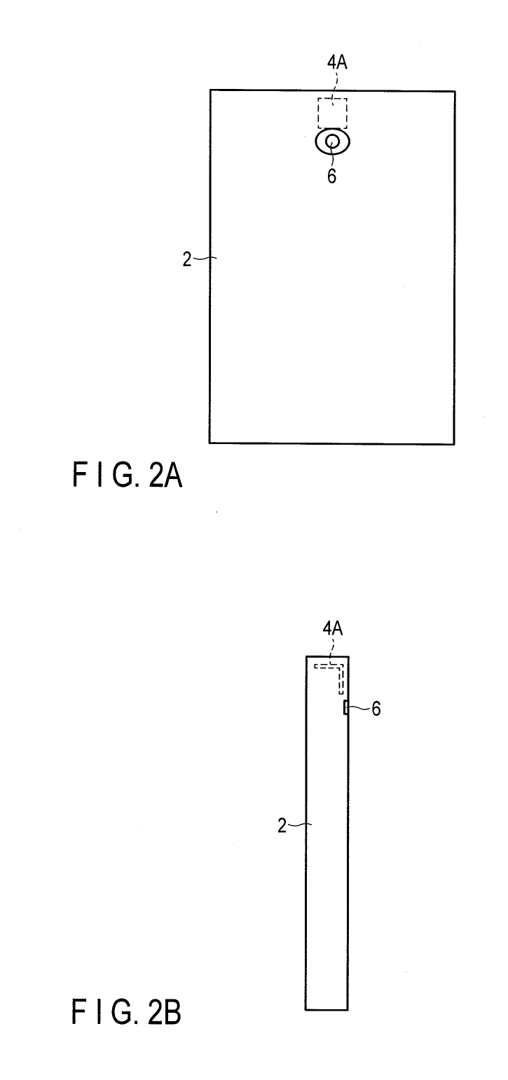

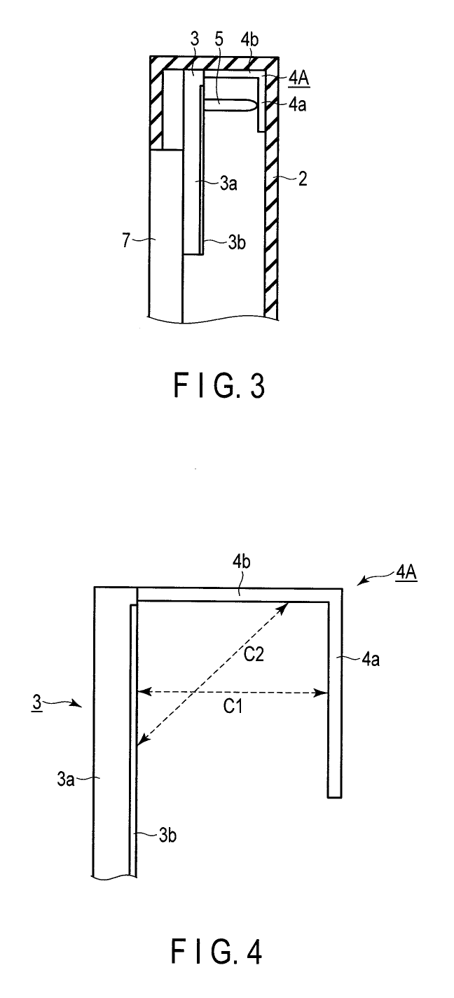

FIG. 1 is a perspective view illustrating a non-contact proximity-type communication apparatus of a first embodiment and FIGS. 2A and 2B are rear view and side view of a mobile information terminal 1, respectively. Furthermore, FIG. 3 is a cross-sectional side view illustrating an enlarged part of the mobile information terminal 1, on which the non-contact proximity-type communication apparatus is placed.

The mobile information terminal 1 is, for example, a smart phone or tablet-type terminal and a casing 2 thereof stores a substrate 3 and non-contact proximity-type communication apparatus. Here, reference numeral 6 indicates a camera and reference numeral 7 indicates a tablet-type indicator.

The substrate 3 is a substrate body 3a on which a grounding pattern 3b and feed pattern (not shown) are formed, and the feed pattern is connected to a wireless circuit which is not shown via a high-frequency cable and the like.

A non-contact proximity-type communication method is a data communication method using a high-frequency band (for example, Felica (Trademark): 13.56 MHz, TransferJet (Trademark): 4.48 GHz) in which one non-contact proximity-type communication apparatus of a terminal communicates with a non-contact proximity-type communication apparatus of the other terminal in the vicinity thereof with utilizing electromagnetic induction or induction field acting as a communication medium. Here, in the non-contact proximity-type communication method, a communication method using electromagnetic induction such as Felica (Trademark) or a communication method using induction field such as TransferJet (Trademark) may be used, and in this embodiment, a case where the latter-mentioned induction field method is used as an example.

The non-contact proximity-type communication apparatus comprises a coupling element (coupler) 4A and feed pin 5. The coupling element 4A comprises two orthogonal pieces and formed by bending a conductive material such as copper, aluminum and the like into an L-letter shape. The coupling element 4A is located in the casing 2 of the mobile information terminal 1, so as to be placed at the center of the upper corner surface of the casing 2. That is, the coupling element 4A have the two pieces; namely, a vertical piece 4a and horizontal piece 4b contact with the upper corner surface and rear corner surface of the casing, respectively, as shown in FIG. 3. Here, a fixing member to fix the coupling element 4A onto the inner surface of the casing 2 may be, for example, an adhesive agent or adhesive tape but is not limited thereto.

The feed pin 5 is, for example, a coil spring, plate spring, or the like, and a proximal end thereof is fixed onto the feed pattern of the substrate by, for example, soldering while a distal end thereof is provided to contact the vertical piece of the two pieces of the coupling element 4A. With the feed pin 5, the coupling element 4A is electrically connected to the wireless circuit which is not shown.

With such a structure, a transmit signal output from the wireless circuit which is not shown is supplied to the coupling element 4A via the high-frequency cable, feed pattern, and feed pin 5. Then, electromagnetic wave modulated by the transmit signal is radiated from each of the vertical piece 4a and horizontal piece 4b of the coupling element 4A. Thus, when a terminal of a communication party (not shown), which has substantially similar structure as that of the communication terminal, is placed within the proximity to oppose to the vertical piece 4a or horizontal piece 4b of the coupling element 4A, the mobile information terminal 1 can transmit data to the similarly-structured terminal of the communication party using the non-contact proximity-type communication method. Furthermore, electromagnetic wave radiated from the similarly-structured terminal of the communication party is received by the coupling element 4A, converted into a received signal by the coupling element 4A, and input in the wireless circuit via the feed pin 5, feed pattern and high-frequency cable. Thereby, the similarly-structured terminal of the communication party can transmit data to the mobile information terminal 1.

Furthermore, the grounding pattern 3a is formed on the substrate 3, and thus, as shown in FIG. 4, stray capacitors having capacitances C1 and C2 are produced between the grounding pattern 3a and vertical piece 4a and between the grounding pattern 3a and horizontal piece 4b, respectively. Thus, communication distances in both vertical and horizontal directions can be extended.

As explained above, in the first embodiment, the coupling element 4A bent into the L-letter shape is placed at the center of the upper end of the mobile information terminal 1 so that the vertical piece 4a and horizontal piece 4b of the coupling element 4A can face the upper surface and rear surface of the casing of the mobile information terminal 1, and an electrical power is supplied to the coupling element 4A from the feed pattern of the substrate 3 via the feed pin 5.

Therefore, by placing the similarly-structured terminal of the communication party to oppose to the upper end surface or rear surface of the mobile information terminal 1 so as to match the coupling elements with each other, data communication of the non-contact proximity-type communication method can be established between the similarly-structured terminal of the communication party and mobile information terminal 1. That is, on whichever surface of the upper end or rear of the mobile information terminal 1 the similarly-structured terminal of the communication party is placed, the data communication can be established between these terminals.

### Embodiment 2

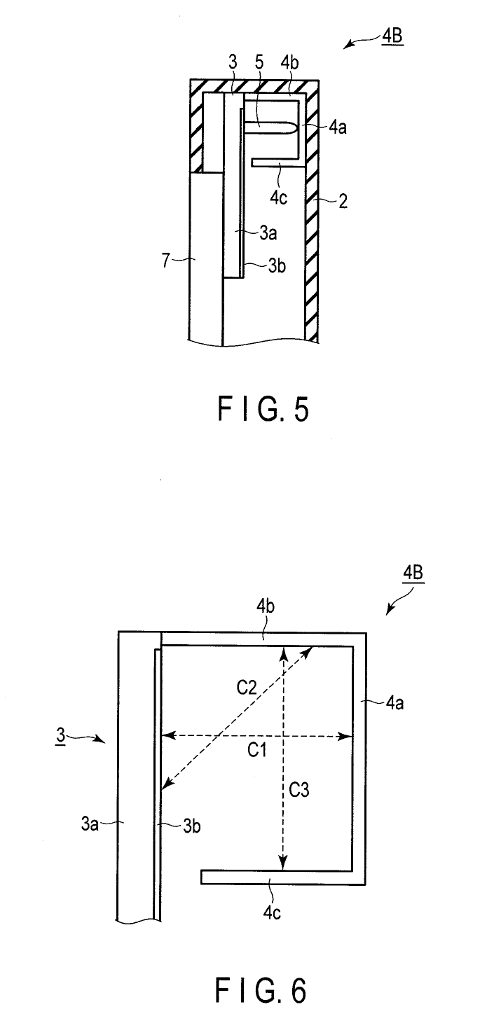

FIG. 5 is a cross-sectional view of a mobile information terminal of a second embodiment, illustrating a part where a non-contact proximity-type communication apparatus is placed. The reference numerals shown in FIG. 3 are applied to the same structural members shown in FIG. 5 and detailed explanation is omitted.

A coupling element 4B is formed by bending a conductive member such as copper, aluminum and the like in a box shape, and comprises a vertical piece 4a and horizontal piece 4b together with an additional element 4c opposite to the horizontal piece 4b. The additional element 4c forms stray capacitors between thereof and vertical piece 4b.

With such a structure, when a transmit signal output from the wireless circuit which is not shown is supplied to the coupling element 4B via the high-frequency cable, feed pattern, and feed pin 5, electromagnetic wave modulated by the transmit signal is radiated from each of the vertical piece 4a and horizontal piece 4b of the coupling element 4B as in the first embodiment. Thus, when a similarly-structured terminal of a communication party (not shown) is placed within the proximity to oppose to the vertical piece 4a or horizontal piece 4b of the coupling element 4B, the mobile information terminal 1 can transmit data to the similarly-structured terminal of the communication party using the non-contact proximity-type communication method. Furthermore, electromagnetic wave radiated from the similarly-structured terminal of the communication party is received by the coupling element 4B, and converted into a received signal by the coupling element 4B, and the received signal input in the wireless circuit via the feed pin, feed pattern, and high-frequency cable. Thereby, the similarly-structured terminal of the communication party can transmit data to the mobile information terminal 1.

Furthermore, the grounding pattern 3a is formed on the substrate 3, and thus, as in the first embodiment, the capacitors having the capacitances C1 and C2 are produced between the grounding pattern 3a and vertical piece 4a and between the grounding pattern 3a and horizontal piece 4b, respectively. Thus, the coupling element can be miniaturized and the communication area can be expanded.

Moreover, the coupling element 4B comprises the additional element 4c. Thus, as shown in FIG. 6, a stray capacitor having a capacitance C3 is generated between the horizontal piece 4b and additional element 4c and the communication distance in the vertical direction can be further extended.

### Embodiment 3

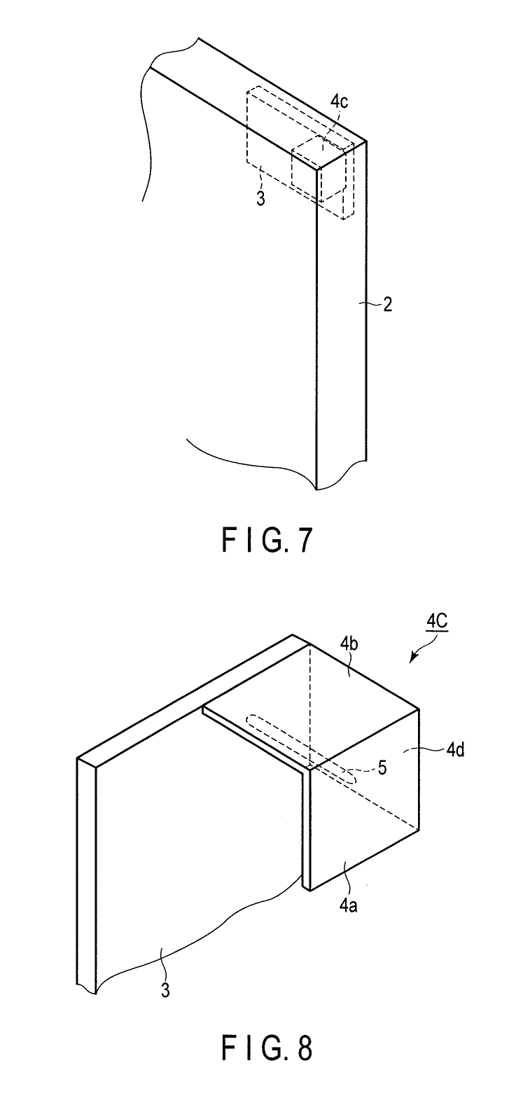

FIG. 7 is a perspective view illustrating a main part of a mobile information terminal comprising a non-contact proximity-type communication apparatus of a third embodiment, and FIG. 8 is a perspective view illustrating an enlarged structure of the non-contact proximity-type communication apparatus. The reference numerals shown in FIGS. 1 to 3 are applied to the same structural members shown in FIGS. 7 and 8 and detailed explanation is omitted.

A coupling element 4C comprises three orthogonal pieces 4a, 4b, and 4c as shown in FIG. 8, and is formed by pressing a metal plate of conductive material such as copper, aluminum, and the like. The coupling element 4C is, as shown in FIG. 7, placed at a corner of an upper end of a casing 2 of a mobile information terminal 1. Here, at a corner inside the casing 2, a vertical piece 4a and horizontal piece 4b are provided on the upper surface and rear surface inside the casing 2, respectively, and a vertical piece 4d is provided on a side surface inside the casing 2.

With such a structure, a transmit signal output from the wireless circuit is supplied to the coupling element 4C via the high-frequency cable, feed pattern, and feed pin 5. Then, electromagnetic wave modulated by the transmit signal is radiated from each of the vertical pieces 4a and 4d, and horizontal piece 4b of the coupling element 4C. Thus, when a similarly-structured terminal of a communication party (not shown) is placed within the proximity to oppose to the vertical pieces 4a and 4d or horizontal piece 4b of the coupling element 4C, the mobile information terminal 1 can transmit data to the similarly-structured terminal of the communication party using the non-contact proximity-type communication method. Furthermore, electromagnetic wave radiated from the similarly-structured terminal of the communication party is received by the coupling element 4C, converted into a received signal by the coupling element 4C, and input in the wireless circuit via the feed pin, feed pattern, and high-frequency cable. Thereby, the similarly-structured terminal of the communication party can transmit data to the mobile information terminal 1.

Therefore, by placing the similarly-structured terminal of the communication party to oppose to the upper end surface, rear surface, or side surface of the mobile information terminal 1 so as to match the coupling elements with each other, data communication of the non-contact proximity-type communication method can be established between the similarly-structured terminal of the communication party and mobile information terminal 1. That is, on whichever surface of the upper end, rear, or side of the mobile information terminal 1 the similarly-structured terminal of the communication party is placed, the data communication can be established between these terminals.

### Embodiment 4

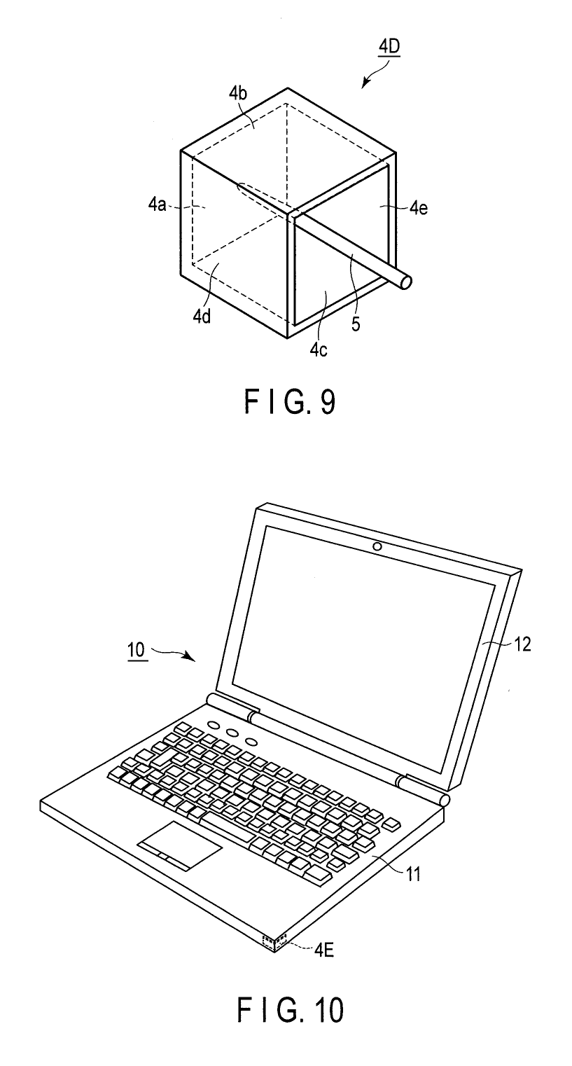

FIG. 9 is a perspective view illustrating an enlarged structure of a non-contact proximity-type communication apparatus of a fourth embodiment. The reference numerals shown in FIG. 8 are applied to the same structural members shown in FIG. 9 and detailed explanation is omitted.

A coupling element 4D comprises five orthogonal pieces 4a, 4b, 4c, 4d, and 4e as shown in FIG. 9, and is formed by pressing a metal plate of conductive material such as copper, aluminum, and the like. The coupling element 4D is, as shown in FIG. 7, placed at a corner of an upper end of a casing 2 of a mobile information terminal 1. Here, at a corner inside the casing 2, a vertical piece 4a and horizontal piece 4b are provided on an upper surface and rear surface inside the casing 2, respectively. Each of the horizontal surface 4c and vertical surface 4e is functional as an additional element generating capacity between the horizontal surface 4b and vertical surface 4d, respectively. Regarding a feed pin 5, the proximal end thereof is, as in FIG. 8, fixed to the substrate 3 and the distal end thereof is inserted in an opening of the coupling element 4D to contact the vertical piece 4a.

With such a structure, a transmit signal output from the wireless circuit is supplied to the coupling element 4D via the high-frequency cable, feed pattern, and feed pin 5. Then, as in the third embodiment, electromagnetic wave modulated by the transmit signal is radiated from each of the vertical pieces 4a and 4d, and horizontal piece 4b of the coupling element 4C. Thus, when a similarly-structured terminal of a communication party (not shown) is placed within the proximity to oppose to the vertical pieces 4a and 4d or horizontal piece 4b of the coupling element 4D, the mobile information terminal 1 can transmit data to the similarly-structured terminal of the communication party using the non-contact proximity-type communication method. Furthermore, electromagnetic wave radiated from the similarly-structured terminal of the communication party is received by the coupling element 4D, converted into a received signal by the coupling element 4D, and input in the wireless circuit via the feed pin, feed pattern, and high-frequency cable. Thereby, the similarly-structured terminal of the communication party can transmit data to the mobile information terminal 1.

Therefore, in the fourth embodiment, as with the third embodiment, by placing the similarly-structured terminal of the communication party to oppose to the upper end surface, rear surface, or side surface of the mobile information terminal 1 so as to match the coupling elements with each other, data communication of the non-contact proximity-type communication method can be established between the similarly-structured terminal of the communication party and mobile information terminal 1. That is, on whichever surface of the three surfaces of the mobile information terminal 1, that is, upper end, rear, or side surface the similarly-structured terminal of the communication party is placed, the data communication can be established between these terminals.

Moreover, the horizontal surface 4c and vertical surface 4e which are functional as additional elements are placed opposing to each other at the horizontal surface 4b and vertical surface 4e, respectively. Thereby, the stray capacitor is produced between the horizontal surfaces 4b and 4c and the vertical surfaces 4d and 4e, respectively, and the capacity miniaturizes the coupling element and expands a communication area.

### Embodiment 5

FIG. 10 is a perspective view illustrating a structure of a note-type personal computer comprising a non-contact proximity-type communication apparatus of a fifth embodiment.

A note-type personal computer 10 comprises a first casing 11 on which a keyboard and mouse pad are placed and a second casing 12 on which a display 12 is placed are connected in an openable/closable fashion by a hinge mechanism.

A non-contact proximity-type communication apparatus is placed at one corner of a front end portion inside the first casing 11. The non-contact proximity-type communication apparatus comprises a coupling element 4E formed in an L-letter shape. The coupling element 4E is placed so that one piece of the coupling element 4E opposes to a front end surface of the first casing 11 while the other piece oppose to a side surface of the first casing 11. To the coupling element 4E, a transmit signal output from the wireless circuit (which is not shown) stored inside the first casing 11 is supplied via a high-frequency cable, feed pattern, and feed pin 5 which are not shown as with the first embodiment.

With such a structure, the transmit signal output from the wireless circuit is supplied to the coupling element 4E via the high-frequency cable, feed pattern, and feed pin 5, and then, electromagnetic wave modulated by the transmit signal is radiated from each of the orthogonal pieces. Thus, when, for example, the mobile information terminal 1 described in the first or third embodiment is placed within the proximity to oppose to either one of the two pieces of the coupling element 4E of the note-type personal computer 10, the note-type personal computer 10 can transmit data to the mobile information terminal 1 using the non-contact proximity-type communication method. Furthermore, electromagnetic wave radiated from the mobile information terminal 1 of a communication party is received by the coupling element 4E, converted into a received signal by the coupling element 4E, and input in the wireless circuit via the feed pin 5, feed pattern, and high-frequency cable. Thereby, the mobile information terminal 1 of the communication party can transmit data to the note-type personal computer 10.

Therefore, in the fifth embodiment, by placing the mobile information terminal 1 such as a smart phone and the like to oppose to either front end surface or side end surface of the note-type personal computer 10 so as to match the coupling elements with each other, data communication of the non-contact proximity-type communication method can be established between the mobile information terminal 1 and note-type personal computer 10.

In other words, at both front end and side end of the note-type personal computer 10, the mobile information terminal 1 can perform data communication with the note-type personal computer 10. Therefore, the user's operability can be improved significantly as compared to a case where the mobile information terminal is placed on a portion so-called “palm rest” which is, for example, between the front end of the first casing 11 of the note-type personal computer 10 and keyboard.

### Embodiment 6

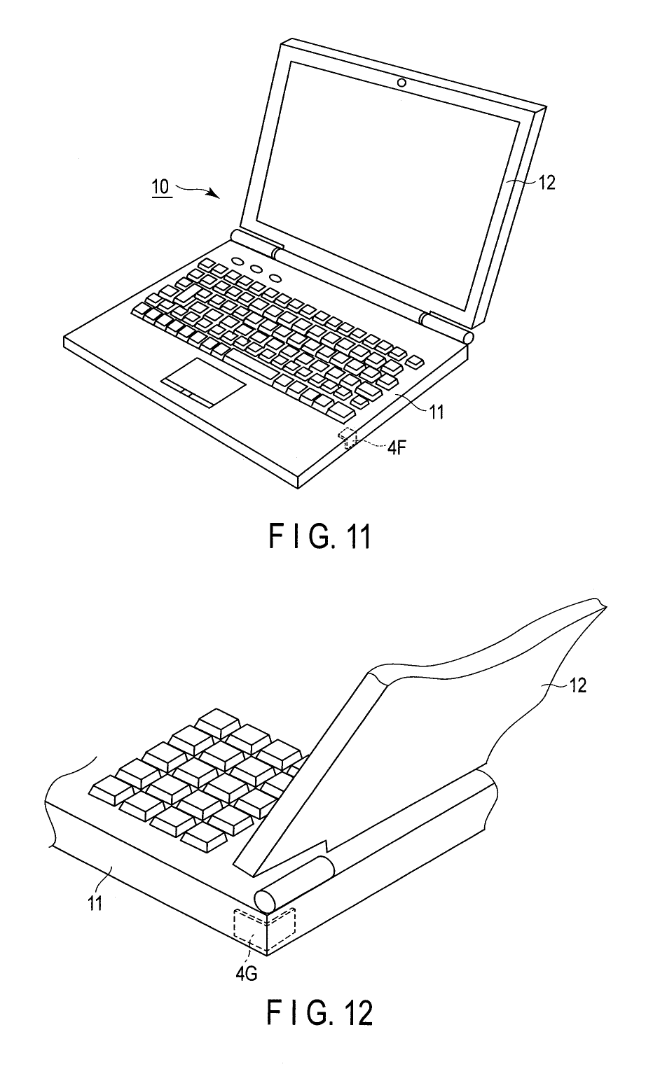

FIG. 11 is a perspective view illustrating a structure of a note-type personal computer comprising a non-contact proximity-type communication apparatus of a sixth embodiment. The reference numerals shown in FIG. 10 are applied to the same structural members shown in FIG. 11 and detailed explanation is omitted.

In the sixth embodiment, a coupling element 4F bent in an L-letter shape as in the fifth embodiment is placed to cover from an upper surface to side surface of a casing 11 at a palm rest portion of a note-type personal computer 10.

With such a structure, electromagnetic wave modulated by the transmit signal is transmitted from the two pieces of the coupling element 4F to each of the upper and side surface directions of the note-type personal computer 10. Generally, when a non-contact proximity-typeIC card is used as a mobile information terminal of a communication party, it is difficult to place the non-contact proximity-typeIC card to lean on a side surface of a first casing 11 of the note-type personal computer 10. In contrast, in the sixth embodiment, a stable data communication can be established while the non-contact proximity-typeIC card is placed on the palm rest of the note-type personal computer 10.

Here, depending on a kind of non-contact proximity-typeIC card, a coupling element may not be placed on an end portion of the card, and in such a case, the length of the coupling element 4F may be extended from the end portion of the palm rest to the center thereof. The arrangement of the coupling element 4F in the depth direction of the palm rest may be configured optionally based on the non-contact proximity-typeIC card used therein.

### Embodiment 7

FIG. 12 is a perspective view illustrating a structure of a note-type personal computer comprising a non-contact proximity-type communication apparatus of a seventh embodiment. The reference numerals shown in FIG. 10 are applied to the same structural members shown in FIG. 12 and detailed explanation is omitted.

In the seventh embodiment, a coupling element 4G bent in an L-letter shape as in the fifth embodiment is placed at one corner in a rear end portion of a first casing 11 of a note-type personal computer 10. More specifically, in the first casing 11, one of the two orthogonal pieces of the coupling element 4G is placed to oppose to a side end surface of the casing 11 and the other piece is placed to oppose to a rear end surface of the casing 11.

With such a structure, electromagnetic wave modulated by the transmit signal is transmitted from the two pieces of the coupling element 4G to each of the rear surface and side surface directions of the note-type personal computer 10. Thus, by placing a mobile information terminal 1 such as a smart phone and the like to oppose to the rear end surface or side end surface of the note-type personal computer 10 so as to match the coupling elements with each other, a stable data communication therebetween can be established using the non-contact proximity-type communication method.

In other words, at both rear end and side end of the note-type personal computer 10, the mobile information terminal 1 can perform data communication with the note-type personal computer 10.

### Embodiment 8

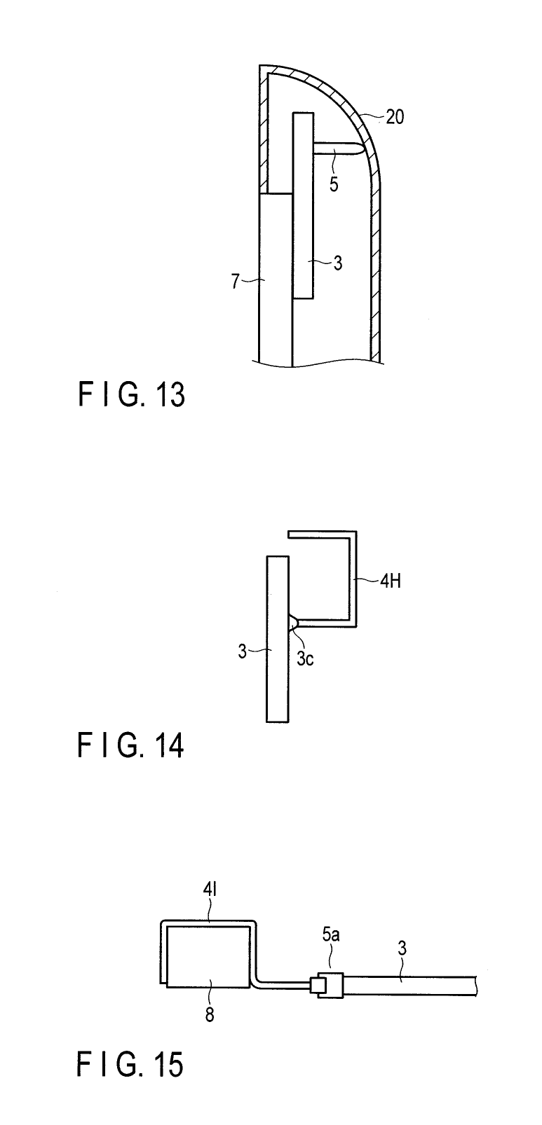

FIG. 13 is a perspective view illustrating a structure of a non-contact proximity-type communication apparatus of an eighth embodiment.

In the eighth embodiment, when a part of a casing of a mobile information terminal is made of a conductive material such as magnesium, aluminum, and the like, the part made of the conductive material of the casing 20 is used as a coupling element. A feed pin 5 is placed while proximal end portion thereof is fixed to a substrate 3 and distal end portion thereof contacts to the part of the casing 20 made of the conductive material to be used as the coupling element. In the example of FIG. 13, the end portion of the casing 20 is a bending surface and the coupling element contacts the bending surface.

With such a structure, electromagnetic wave can be irradiated from a plurality of surfaces of the casing 20 made of the conductive material which is used as the coupling element, and thereby, multidirectional communication is achievable. Furthermore, since a part of the casing 20 made of the conductive material is used as the coupling element, there is no necessity of preparing a separate material to be used as a coupling element or storing thereof in the casing, and thus, the number of essential elements and the production cost can be reduced, the terminal can be further miniaturized, and high implementation can be achieved.

### Embodiment 9

FIG. 14 is a side view illustrating a non-contact proximity-type communication apparatus of a ninth embodiment.

In the ninth embodiment, a coupling element 4H is bent in a Japanese “ [symbol] ” letter shape, and one end portion thereof is directly fixed to a feed pattern formed on a substrate 3 by means of soldering and the like. In FIG. 14, reference numeral 3c indicates a part of soldering.

With such a structure, a feed pin 5 is not necessary and thus, the number of essential elements and the production cost can be reduced.

### Embodiment 10

FIG. 15 is a side view illustrating a structure of a non-contact proximity-type communication apparatus of a tenth embodiment.

In the tenth embodiment, a coupling element 4I bent in a Japanese “a” letter shape is structured by forming a substrate 8 of a resin material in a square shape and placing flexible print circuits (FPC) along the surface shape of the substrate 8. The proximal end portion of the FPC structuring the coupling element 4I is connected to a feed pattern of the substrate 3 via a connector 5a. Thereby, feeding to the coupling element 4I is performed.

With such a structure, a production process of bending and pressing a metal plate can be omitted.

### Embodiment 11

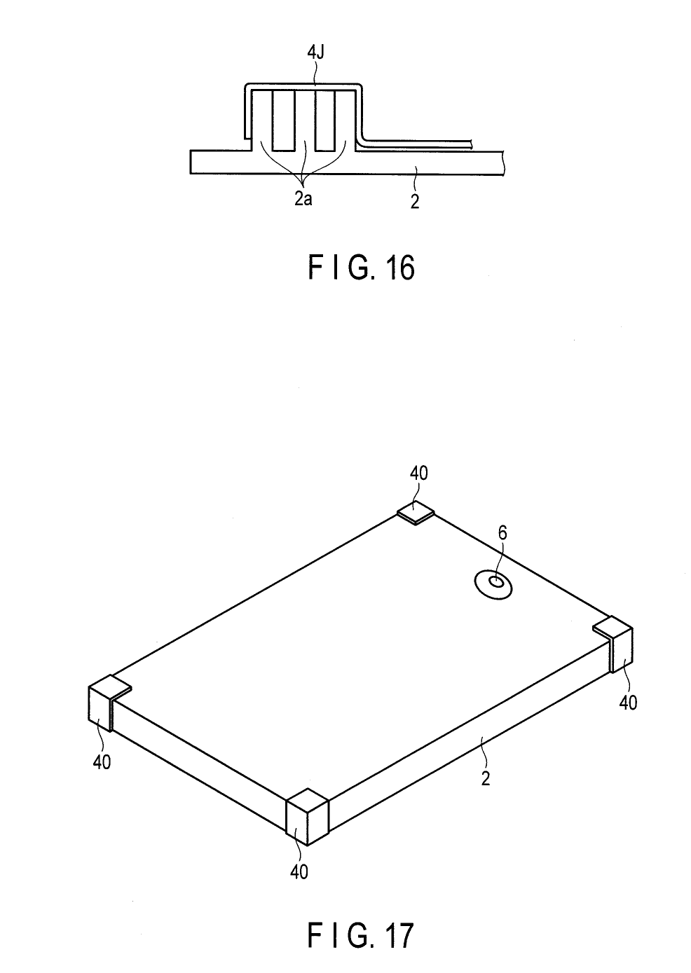

FIG. 16 is a side view illustrating a non-contact proximity-type communication apparatus of an eleventh embodiment.

In the eleventh embodiment, a coupling element 4J bent in a box shape is structured by forming projections 2a at a part of a casing 2 formed of a resin material and placing FPC along the surface shape of the projection 2a. As with FIG. 15, the proximal end portion of the FPC structuring the coupling element 4J is connected to a feed pattern of a substrate 3.

With such a structure, when producing the casing 2 formed of a resin material by die-casting method, the projection 2a can be produced together, and thus, there is no need of separately producing a resin base 8 used in the tenth embodiment. The production cost can be reduced.

### Embodiment 12

FIG. 17 is a perspective view illustrating a structure of a mobile information terminal comprising a non-contact proximity-type communication apparatus of a twelfth embodiment.

In the twelfth embodiment, a mobile information terminal includes metal reinforcing members at four corners thereof, and one of the four members is used to act as a coupling element 40. The metal reinforcing member has two vertical pieces orthogonal to each other and two horizontal pieces parallel with each other. The vertical pieces and horizontal pieces are used as radiation pieces of electromagnetic wave.

With such a structure, a reinforcing member can be used as a coupling element 40, and thus, there is no necessity of preparing a separate material to be used as a coupling element or storing thereof in the casing, and thus, the number of essential elements and the production cost can be reduced.

The four reinforcing members may be selectively used as a coupling element. This is achieved by, for example, providing a switch between the four reinforcing members and a wireless circuit, detecting a direction of a mobile information terminal based on a three-dimensional sensor and the like, and switching the switch based on the detected direction. Furthermore, a user may select the four reinforcing members optionally by a key select. With such structures, any of the four reinforcing members at the four corners of the mobile information terminal can be used as the coupling element 40.

### Other Embodiments

A coupling element may be bent in a shape other than a rectangular shape, and the shape and the number of pieces of the other coupling members can be changed in various ways. Other than a feed pin, a feed member may be a plate spring formed by bending a metal piece in a L shape. Additionally, a kind of a mobile information terminal and structure thereof, shape of a casing, arrangement of a coupling element with respect to the mobile information terminal, and fixing means thereof can be changed and achieved in various ways.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-contact proximity-type communication apparatus implemented on a wireless terminal comprising a wireless circuit which transmits/receives a communication signal, and configured to transmit/receive the communication signal with another terminal using an induction electric field type non-contact communication method, the apparatus comprising:
a coupling element comprising at least two pieces whose surfaces face different directions, the coupling element electrically connected to the wireless circuit and placed at an end portion of the terminal.

2. The non-contact proximity-type communication apparatus of claim 1, wherein the coupling element comprises first and second pieces bent to cross each other at a right angle or an angle close thereto, and the first and second pieces are placed at an end portion of the terminal so as to oppose to first and second surfaces different from each other of a terminal casing.

3. The non-contact proximity-type communication apparatus of claim 1, wherein the coupling element comprises first and second pieces bent to cross each other at a right angle or an angle close thereto, and the first and second pieces are placed at an end of the terminal so as to oppose to first and second continuous surfaces of a terminal casing via a curved surface portion thereof.

4. The non-contact proximity-type communication apparatus of claim 2 or 3, wherein the apparatus further comprises a first additional element placed to oppose to the first or second piece and formed of a conductive material which is in capacitive coupling to the first or second piece.

5. The non-contact proximity-type communication apparatus of claim 1, wherein the coupling element comprises first, second, and third pieces bent to cross each other at a right angle or an angle close thereto, and the first, second, and third pieces are placed at corners of the terminal so as to oppose to first, second, and third surfaces different from each other of a terminal casing.

6. The non-contact proximity-type communication apparatus of claim 1, wherein the coupling element comprises first, second, and third pieces bent to cross each other at a right angle or an angle close thereto, and the first, second, and third pieces are placed at corners of the terminal so as to oppose to first, second, and third continuous surfaces of a terminal casing via a curved surface portion thereof.

7. The non-contact proximity-type communication apparatus of claim 5, wherein the apparatus further comprises a second additional element placed to oppose to at least two of the first, second, and third pieces and formed of a conductive material which is in capacitive coupling to the two pieces.

8. The non-contact proximity-type communication apparatus of claim 6, wherein the apparatus further comprises a second additional element placed to oppose to at least two of the first, second, and third pieces and formed of a conductive material which is in capacitive coupling to the two pieces.

9. The non-contact proximity-type communication apparatus of claim 1, wherein the apparatus further comprises a feed member configured to electrically connect between the coupling element and the wireless circuit.

10. An information terminal comprising:
a wireless circuit configured to transmit/receive a communication signal;
a non-contact proximity-type communication unit configured to transmit/receive the communication signal to/from another terminal device using an induction electric field type non-contact communication method; and
a casing configured to store the wireless circuit and the non-contact proximity-type communication unit, wherein the non-contact proximity-type communication apparatus comprises a coupling element comprising at least two pieces whose surfaces face different directions, electrically connected to the wireless circuit, and placed at an end portion of the casing.
